(19) United States
(12) Patent Application Publication
(10) Pub. No.: US 2005/0268779 A1
(43) Pub. Date: Dec. 8, 2005

(54) Electrostatic switch for hydrogen storage and release from hydrogen storage media

(76) Inventors: Qinbai Fan, Chicago, IL (US); Michael Onischak, St. Charles, IL (US)

Correspondence Address: Mark E. Fejer;Gas Technology Institute, 1700 South Mount Prospect Road, Des Plaines, IL, 60018, US

(21) Appl. No.: 10/859,671

(22) Filed: Jun. 3, 2004

(51) Int. Cl. B03C 3/00

(52) U.S. Cl. 95/57

(57) ABSTRACT

A method and apparatus for storing molecular hydrogen in which a material suitable for storage of molecular hydrogen is electrostatically charged, forming an electrostatically charged material. The electrostatically charged material is then contacted with molecular hydrogen, resulting in adsorption of the molecular hydrogen by the electrostatically charged material.

### BACKGROUND OF THE INVENTION

1. Field of the Invention

This invention relates to a method and apparatus for storage of molecular gases, e.g. hydrogen, oxygen, chlorine, fluorine, etc. More particularly, this invention relates to a method and apparatus for storage of molecular gases in which the molecular gas storage medium may be electrostatically charged and gas uptake by and release from the molecular gas storage medium is controlled by an electrostatic charger. Even more particularly, this invention relates to a method and apparatus for storage of molecular hydrogen.

2. Description of Related Art

Hydrogen is the most abundant element on earth and, because it is essentially non-polluting, forming water upon oxidation, offers great potential as an energy source. Of particular interest is the use of hydrogen as an energy source in fuel cells for generation of power in stationary, portable and vehicular/transportation applications. However, cost-effective storage of hydrogen remains a significant barrier to the widespread use of hydrogen as an energy source. For vehicular/transportation applications, the overriding issue which needs to be addressed is storage of the amount of hydrogen required to provide a traditional driving range, at least about 300 miles, within the vehicular constraints of safety, weight, volume, efficiency and refueling times. More particularly, an effective hydrogen storage system for vehicular/transportation applications requires quick charge and discharge, high wt % storage capacity with small volumes, durability over many cycles, and safe handling and transport. Hydrogen storage is also a requirement for delivery of hydrogen from production sites, at hydrogen refueling stations and at stationary power sites.

One method for storing hydrogen having the potential to address these issues is storage in materials as “bonded” hydrogen. There are, at present, three basic paths known for storage of hydrogen in materials: absorption in which the hydrogen is absorbed directly into the absorbing material, such as metal hydrides; adsorption, which is comprised of both physisorption and chemisorption mechanisms, in which the hydrogen is energetically bound to the adsorbing material, such as carbon-based materials; and chemical reaction.

Hydrogen storage on carbon-based materials has been under investigation since the 1960's. The carbon-based materials include graphite, nanocarbon fibers, fullerenes, carbon nanotubes and nanohorns. Typical hydrogen storage capacities on carbon single-wall nanotubes have been reported in the range of about 2-4 wt %. In recent years, a substantial amount of investigation has focused on tubular shape molecules for hydrogen storage. However, the cost of the materials is very high and the rates of hydrogen storage within these materials seem not to be reproducible. In addition, the temperatures required for storage of hydrogen in these materials are very low, e.g. on the order of liquid nitrogen.

Hydrogen is typically physisorbed on carbon-based and other non-polar materials. In addition, hydrogen is also a non-polar molecule. The non-polar hydrogen molecules are adsorbed on the non-polar carbon-based material non-dissociately. The force between these two non-polar species is an intermolecular force, basically the weak Van der Waals force. However, if this weak adsorption force could be increased by polarizing the carbon-based substrate material, the hydrogen storage capacity of the carbon-based substrate material would be increased.

### SUMMARY OF THE INVENTION

It is, thus, one object of this invention to provide a method and apparatus for storing gaseous molecules having an intermolecular affinity for electrons.

It is one object of this invention to provide a method and apparatus for storing hydrogen.

It is another object of this invention to provide a method and apparatus for storing hydrogen whereby the amount of hydrogen able to be stored is increased over conventional hydrogen systems.

It is yet another object of this invention to provide a method and apparatus for storing hydrogen which provides reversible hydrogen storage, that is rapid charge and controlled discharge of the hydrogen.

It is still a further object of this invention to provide a method and apparatus for storing hydrogen which is suitable for use in vehicular/transportation applications.

These and other objects of this invention are addressed by a method for storing gaseous molecules having an affinity for electrons comprising the steps of electrostatically charging a material suitable for storage of the gaseous molecules to form an electrostatically charged material and contacting the electrostatically charged material with the gaseous molecules, resulting in adsorption of the gaseous molecules by the electrostatically charged material. Any material which is porous to the gaseous molecules, that is having internal spaces of sufficient size to accommodate the gaseous molecules, and which is capable of accepting an electrostatic charge is suitable as a material for storage of the gaseous molecules in accordance with this invention. In accordance with one preferred embodiment of this invention, the gaseous molecules are hydrogen molecules and preferred materials suitable for storage of the molecular hydrogen in accordance with one embodiment of this invention are carbon-based materials, e.g. graphite. Carbon-based materials offer the particular benefit relative to other materials suitable for storage of hydrogen, such as metal hydrides, of being lightweight.

These and other objects of this invention are also addressed by an apparatus for storage of gaseous molecules comprising a gaseous-molecule storage medium and charging means for electrostatically charging the gaseous-molecule storage medium. Any material which is porous to the gaseous molecules as described above and which is capable of accepting an electrostatic charge is suitable as a gaseous molecule storage medium. In accordance with one preferred embodiment of this invention, the storage medium is adapted to storing molecular hydrogen. Preferred materials for use as a molecular hydrogen storage medium in accordance with one embodiment of this invention are carbon-based materials.

It will be apparent to those skilled in the art that electrostatic charging of the gaseous-molecule storage material in accordance with one embodiment of this invention adds an electrical potential to the gaseous-molecule storage medium, thereby increasing the polarization of the gaseous-molecule storage material. In accordance with one embodiment of this invention, polarization of the gaseous-molecule storage material is further enhanced by the deposit and/or intercalation of electron-rich materials, such as metals, and/or electron hungry materials, such as nitrogen atoms, phosphor and the like.

### BRIEF DESCRIPTION OF THE DRAWINGS

These and other objects and features of this invention will be better understood from the following detailed description taken in conjunction with the drawings wherein:

FIG. 1 is a schematic diagram showing modification of graphite flakes to produce a more suitable hydrogen storage material in accordance with one embodiment of this invention; and

FIG. 2 is a schematic diagram of an electrostatic charger suitable for use in the method and apparatus of this invention.

### DETAILED DESCRIPTION OF THE PRESENTLY PREFERRED EMBODIMENTS

The fundamental element of the invention claimed herein is the application of an electrostatic charge to materials that are suitable for storage of gaseous molecules, such as molecular hydrogen, as a means for increasing the storing capacity of the gaseous-molecule storage materials. Accordingly, any material having sufficient porosity to intake the gaseous molecules that is capable of accepting an electrostatic charge may be employed in the method and apparatus of this invention. Such materials include, but are not limited to, metal hydrides, zeolites, glass micro-spheres, alanates, magnesium alloys and carbon-based materials. By sufficient porosity, we mean a porous material having sufficiently large open internal spaces to receive the gaseous molecules. Larger spaces may be employed and may, in fact, be desirable depending upon the amount of gaseous molecules desired to be stored. It will, however, be apparent to those skilled in the art that with larger spaces comes the potential for molecules larger than the desired gaseous molecules, e.g. water, and other impurities to enter the spaces of the storage material, thereby potentially reducing the storing capacity of the storage material. In such cases, it may be desirable to separate such larger molecules from the desired gaseous molecules prior to introducing the gaseous molecules into the gaseous-molecule storage material. It is to be understood that, although the focus of the description of this invention is on the storage of molecular hydrogen, the method and apparatus of this invention may be employed for storing any gaseous molecules having an intermolecular affinity for electrons, e.g. oxygen, chlorine, fluorine, H₂S, etc. and such gaseous molecules are deemed to be within the scope of this invention.

In accordance with one embodiment of this invention, the gaseous molecules are hydrogen molecules and the preferred hydrogen storage materials are carbon-based materials. As used herein, the term “carbon-based material” refers to a material comprising carbon. As previously indicated, carbon-based materials are generally lightweight and, as such, offer a highly favorable weight ratio of hydrogen storage material to stored hydrogen. In accordance with one preferred embodiment, the carbon-based material comprises an expanded (exfoliated) graphite material. Normal graphite is typically comprised of a plurality of graphite layers. However, the distances between adjacent graphite layers is generally less than the size of hydrogen molecules. As a result, in its naturally occurring state, graphite is generally unable to uptake significant amounts of hydrogen due to the insufficiency in the distance between adjacent graphite layers. However, expanded graphite as used in this invention is a carbon-based material which has been treated to increase the distance between adjacent graphite layers to an amount of at least about the diameter of molecular hydrogen.

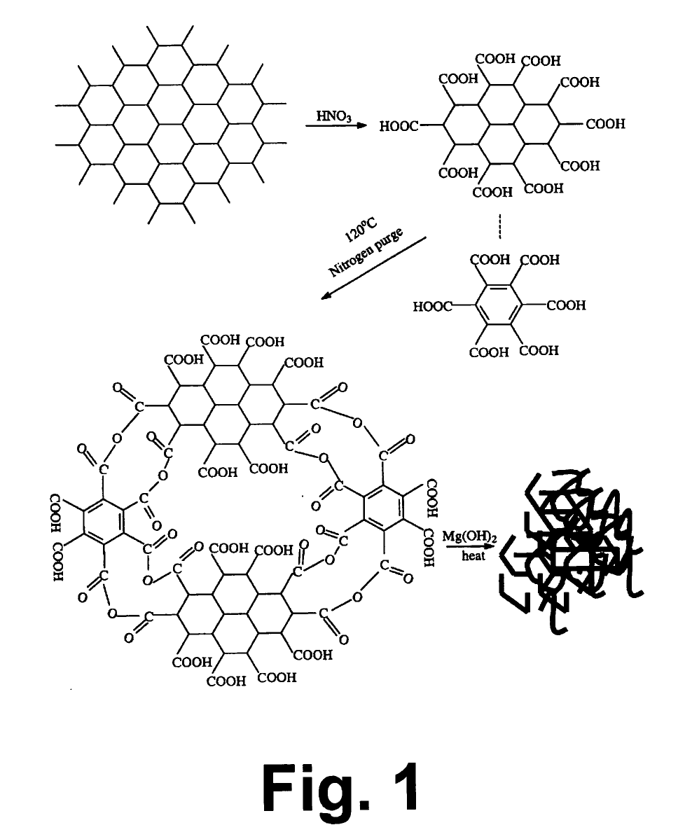

Expanded graphite is produced, as shown in FIG. 1, by first oxidizing a graphite powder, which may be in the form of flakes, particles, etc., using a strong acid solution. Preferred strong acid solutions are about 40 wt % HNO₃ and/or 40 wt % H₂SO₄. During this process, the acid molecules are inserted (intercalated) between the graphite layers, producing a “graphite salt” or expandable graphite. The expandable graphite is then heat treated at temperatures in the range of about 800° C. to about 1300° C., during which the acid molecules, before departing from the graphite structure, “push” the graphite layers apart, thereby producing an expanded graphite, that is, layered graphite having an increased interlayer distance, preferably greater than about the diameter of hydrogen molecules. The electrical conductivity properties of the expanded graphite are an order of magnitude higher than non-expanded graphite.

During the graphite expansion process as shown in FIG. 1, oxidation of the graphite flakes with a strong acid produces carboxylic acid disposed around graphite flakes having different particle sizes. These oxidized graphite flakes may be dehydrated intra-molecularly and inter-molecularly. This procedure is dependent on time and temperature to form the different structural shapes, i.e. cage-type, twisted flakes, etc. The regrouped particles decarboxylate to remove carboxylic dehydrates at the same time. To prevent the expanded graphite material from compressing so as to reduce the distance between graphite layers to a distance less than the size of a hydrogen molecule, thereby preventing uptake by the graphite material of the hydrogen, in accordance with one embodiment of this invention, the decarboxylation process also intercalates electron donor metals, for example Mg, which may be needed to back donate electrons to the d-band of the carbon atoms, thereby changing the carbon electronic configuration to change hydrogen adsorption from physisorption (nondissociative) to chemisorption (dissociative). The combination of physisorption and chemisorption of hydrogen on the modified carbon-based powders can improve the hydrogen storage capacities and the hydrogen charge and discharge cycles.

It will be apparent to those skilled in the art that other means for producing porous carbon-based materials suitable for use in the method and apparatus of this invention exist, and such other means and the materials produced thereby are deemed to be within the scope of this invention. One such method comprises the molding of suitably sized carbon particles into a desired shape, e.g. a plate, and sintering the molded plate, producing a porous carbon plate.

As previously indicated, in accordance with one embodiment of this invention, the carbon-based materials are intercalated or otherwise doped with materials suitable for back-donating electrons to the d-space, not only for the purpose of favorably altering the electrical properties of the carbon-based material, but also for the purpose of preventing reduction of the interlayer distances during use of the material. However, the back donation of electrons to the carbon d-band may not be enough to adsorb hydrogen at a maximum storage rate. In addition, back donation cannot control the hydrogen discharge when it needs to be consumed. Thus, to enable the carbon-based material to adsorb more hydrogen, in accordance with one preferred embodiment of this invention, an electrostatic potential is added to the carbon-based materials during hydrogen intake. When the hydrogen is needed, the electrostatic power can be turned off to release the stored hydrogen.

In accordance with one preferred embodiment of this invention, the modified graphite materials are subjected to additional chemical intercalation or deposition of electron-rich materials with the preferred material being a metal which forms a hydride upon contact with the hydrogen. Which electron donor metal is chosen depends upon the stability of the final materials and the quality of the hydrogen to be stored. In accordance with one preferred embodiment of this invention, the electron donor metal is selected from the group of metals consisting of Mg, Li, Na, Ca, Ni, La, Fe, Ti and mixtures and alloys thereof. In accordance with a particularly preferred embodiment, the electron donor metal is Mg, primarily due to the light weight of the metal and due to the fact that it is not as active as Li and Na. Intercalation can be conducted with the intercalant in any suitable physical form and concentration at temperatures and pressures effective to achieve the desired results in terms of composition of graphite intercalation compounds and their concentration in the material. Typically, the intercalant is in a liquid form and contains one or more first and second group of metals of the Periodic Table. Generally, the carbon-based materials are mixed with sulfuric acid and metal salts after which the mixture is sintered at a temperature suitable for decomposition of the salts.

Carbon-based materials, such as graphite flakes, as previously indicated, can be altered to produce different shapes as shown in FIG. 1. These synthetic graphite powders are different in shape from nanotubes, fullerenes and nanocarbon fibers but nevertheless are able to store more hydrogen than nanotubes, fullerenes and nanocarbon fibers due to their random shapes and controlled densities.

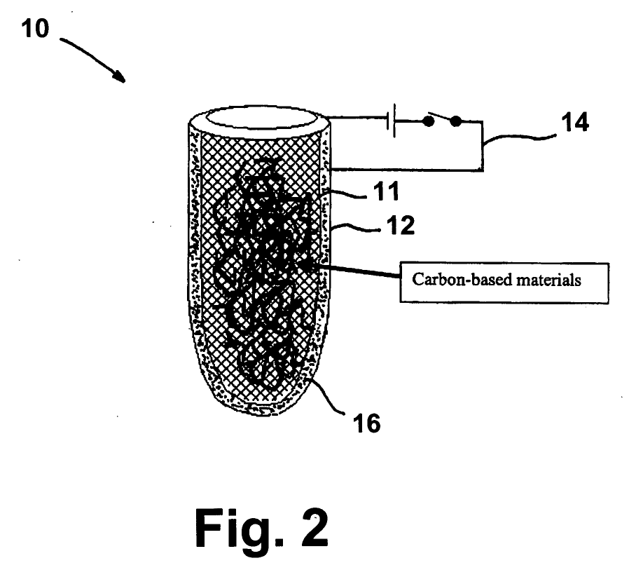

Once it has been modified to produce the desired shape(s), the carbon-based material is placed in a suitable containment vessel, such as an electrostatic Faraday cage as shown in FIG. 2. The electrostatic cage 10 comprises an inner wire mesh cylinder 11 as a charger distributor and container and an outer wire mesh 12, which could be a metal alloy tank, disposed at a distance from the inner wire mesh cylinder 11, as a shield. When charged carbon-based materials are placed inside the closed conducting mesh cylinder 11, they produce equal charges on the outside of the cylinder surface. When a charge producer, e.g. electrostatic charger 14, is applied, the inner surface becomes charged, which immediately balances to the inside carbon-based materials, which have the same amount of charges. A potential is produced between the inner side mesh cylinder 11 and the outside cylinder 12. The greater the charge, the greater the potential is. To prevent discharge or sparks between the inner wire mesh cylinder and the outer wire mesh cylinder, an insulation layer 16 is disposed between the two wire mesh cylinders. When the inner wire mesh cylinder is charged, the carbon-based materials are charged and the hydrogen can be introduced into the inner cylinder. When the stored hydrogen is needed, the charger is turned off to reduce the charges on the carbon-based materials so that the hydrogen can be easily released. Preferred electrostatic charges employed range from about 3V to about 20,000V. Operating temperature for the apparatus is in a range whereby the molecules to be stored are in a gaseous state. Operating temperature for the apparatus whereby the molecules to be stored are hydrogen is preferably in the range of about −20° C. to about 100° C., which range corresponds to the range of operating temperature requirements for vehicular/transportation applications of the claimed invention.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

1. A method for storing hydrogen comprising the steps of:
electrostatically charging a storage material suitable for storage of hydrogen, forming an electrostatically charged material; and
contacting said electrostatically charged material with hydrogen, resulting in adsorption of said hydrogen by said electrostatically charged material.

2. A method in accordance with claim 1, wherein said storage material is a hydrogen-porous, electrostatically chargeable material.

3. A method in accordance with claim 1, wherein said storage material is a carbon-based material.

4. A method in accordance with claim 3, wherein said carbon-based material comprises an exfoliated graphite.

5. A method in accordance with claim 3, wherein at least one electron donor metal is at least one of intercalated and deposited on said carbon-based material.

6. A method in accordance with claim 5, wherein said at least one electron donor metal is able to form a hydride upon contact with said hydrogen.

7. A method in accordance with claim 6, wherein said at least one electron donor metal is selected from the group consisting of Mg, Li, Na, Ca, Ni, La, Fe, Ti and mixtures and alloys thereof.

8. An apparatus for storage of molecular hydrogen comprising:
a molecular-hydrogen storage medium; and
charging means for electrostatically charging said molecular-hydrogen storage medium.

9. An apparatus in accordance with claim 8, wherein said molecular-hydrogen storage medium is a molecular-hydrogen-porous, electrostatically chargeable material.

10. An apparatus in accordance with claim 9, wherein said molecular-hydrogen storage medium comprises a carbon-based material.

11. An apparatus in accordance with claim 10, wherein said carbon-based material is an exfoliated graphite.

12. An apparatus in accordance with claim 10, wherein said molecular-hydrogen storage material is intercalated with at least one electron donor metal.

13. An apparatus in accordance with claim 11, wherein said electron donor metal is able to form a metal hydride upon contact with molecular hydrogen.

14. An apparatus in accordance with claim 13, wherein said electron donor metal is selected from the group consisting of Mg, Li, Na, Ca, Ni, La, Fe, Ti and mixtures and alloys thereof.

15. An apparatus in accordance with claim 14, wherein said electron donor metal is intercalated into said carbon-based material.

16. An apparatus in accordance with claim 11, wherein said carbon-based material comprises a plurality of layers, a distance between said layers being at least about a diameter of molecular hydrogen.

17. An apparatus in accordance with claim 11, wherein said carbon-based material is disposed within a Faraday cage.

18. A method for storage of gaseous molecules having an intermolecular affinity for electrons comprising the steps of:
electrostatically charging a storage material suitable for storage of gaseous molecules having an intermolecular affinity for electrons, forming an electrostatically charged material; and
contacting said electrostatically charged material with said gaseous molecules, resulting in adsorption of said gaseous molecules by said electrostatically charged material.

19. A method in accordance with claim 18, wherein said gaseous molecules are diatomic molecules.

20. A method in accordance with claim 18, wherein said gaseous molecules are hydrogen molecules.

21. A method in accordance with claim 18, wherein said storage material is a gaseous molecule-porous, electrostatically chargeable material.

22. A method in accordance with claim 21, wherein said storage material is a carbon-based material.

23. A method in accordance with claim 22, wherein said carbon-based material is an exfoliated graphite.

24. A method in accordance with claim 23, wherein at least one electron donor metal is at least one of intercalated and deposited on said carbon-based material.

25. A method in accordance with claim 24, wherein said at least one electron donor metal is able to form a hydride upon contact with molecular hydrogen.
